(19) United States
(12) Patent Application Publication
(10) Pub. No.: US 2006/0037794 A1
(43) Pub. Date: Feb. 23, 2006

(54) Instrument panel cover

(76) Inventor: Keith A. Riha, Rochester, MI (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/923,299

(22) Filed: Aug. 20, 2004

(51) Int. Cl. B62D 25/14

(52) U.S. Cl. 180/90

(57) ABSTRACT

A protective cover adapted to overlie at least a portion of a vehicle instrument panel. The protective cover may include a sealing edge that is releasably retainable to the vehicle instrument panel such that when the protective cover is retained to the instrument panel the protective cover may reduce access or accumulation of water, dust, and other contaminants to a portion of the instrument panel.

### FIELD OF THE INVENTION

The present invention relates to a protective cover for a vehicle trim panel, and more particularly to a cover that may be removably disposed on an instrument panel of a vehicle to protect at least a portion of the instrument panel, or components contained therein, from dust, water, and/or other contaminants. The protective cover of the present invention may find particular suitability for use with convertible vehicles and/or vehicles taken off road which are subjected to the elements of weather.

### BACKGROUND OF THE INVENTION

Off road travel, so called “off-roading,” is an increasingly popular recreational activity. The popularity of off-roading has further increased with the growing popularity of sports utility vehicles that are capable of traveling on less developed terrain. Off-roading, however, may often stir up a great deal of dust, mud, water, etc. that may make its way into the interior of the vehicle through open windows, open convertible tops, and, in some cases, through the vehicle's ventilation system.

Whether introduced through an open window or an open convertible top during an activity such as off-roading or simply from remaining open, numerous components of a vehicle may be damaged by contaminants such as dust, water, etc. Electrical components, in car audio systems and switches for power windows, defrosters, etc. are especially susceptible to damage by water and dust. Water may cause electrical systems to short-circuit and contaminants like dust may inhibit the operation of moving parts or controls.

Prior protective devices for instrument panels have largely been directed at protecting the instrument panel area of vehicle from vandalism, sunlight exposure, etc. For example, U.S. Pat. No. 3,557,897 to Deere & Co., entitled “Vehicle Instrument Panel Cover” is directed at a pair of retractable instrument panel covers comprising horizontal pivot means, lock means and latch means which allow a self-storing sturdy cover to unfold and cover the instrument panel of industrial equipment when not in use so as to protect it from vandalism. Similarly, U.S. Pat. No. 3,583,519, also to Deere & Co., entitled “Vehicle Instrument Panel Cover” is directed at a single piece instrument panel cover that swings up and latches into place over the instrument panel to prevent vandalism. U.S. Pat. No. 3,814,205 to Deere & Co. discloses an alternative design for a protective cover including a two-piece, hinged panel that may swing into place over an instrument panel to prevent vandalism in an off-the-road vehicle. U.S. Pat. No. 4,253,357 to Deere & Co. discloses yet another cover design to prevent vandalism in which access to the hinge rod for pivoting the cover is blocked when the cover is in its operative position. U.S. Pat. No. 4,549,625 discloses a still further hinged cover design to prevent vandalism. The cover is disclosed to include flanges for overlapping an instrument panel frame when the cover is in an operative position in order to block access to the instruments in the instrument panel. U.S. Pat. No. 4,131,173 to Fiat-Allis, entitled “Instrument Panel Cover for Vandalism Protection” also discloses a bi-folding, hinged cover that may be locked in place over an instrument panel for preventing vandalism to off-road vehicles, such as construction equipment.

U.S. Pat. No. 4,475,366 to Michael Marneris, entitled “Protective Device For Instruments Mounted On An Instrument Panel” is directed at a device for protecting navigational instruments and radio equipment mounted on an instrument panel in the cockpit of an aircraft against theft.

U.S. Pat. No. 4,979,457 to Sommerhauser, et al., entitled “Support Apparatus For A Protective Covering And The Like” is directed at a support apparatus for positioning a protective cover in a predetermined substantially sheltering attitude relative to an open cockpit of a watercraft. The support apparatus comprises a plurality of adjustable support members extending fore-aft and a yoke. The apparatus is intended to protect the cockpit area of the watercraft from damage due to exposure to sunlight, water or snow, etc.

In addition to devices directed at preventing vandalism or theft, numerous disclosures have been set forth directed at protecting an interior and/or instrument panel from sunlight. For example, U.S. Pat. No. 4,850,635 to George Lindell, entitled “Vehicle Cover Kit” is directed at a protective cover assembly for covering a vehicle's passenger compartment which includes a sheet material wound on a roller. The sheet material may be unrolled over the outside of a vehicle's passenger compartment. Similarly, U.S. Pat. Nos. 5,100,194 and 5,156,433 to Harry L. Decker, entitled “Combination Windshield-Screen Dashboard-Mat Device” are directed at devices which lay on the top of a dashboard to form a mat for protecting the dashboard from sunlight. The mat can also be unfolded and extended to cover the windshield of a vehicle. U.S. Pat. No. 5,114,204 to Bernardo, entitled “Collapsible Interior Sunshade For Unoccupied Motor Vehicle” is directed at a sunshade which may be deployed horizontally across the vehicle's interior to cover the top of the dashboard, front and rear seats, headrests and steering wheel. The sunshade includes a sheet of flexible material, support means, affixing means and a plurality of rigid arms. Finally, U.S. Pat. No. 5,655,810 to Shikler, entitled “Combination Automobile Sunshade And Interior Protective Cover” is directed at an interior sunshade having an elongated cover which extends over the driver's seat to provide visual security and reflective surface for protecting the covered area from the sun.

While there have been a number of disclosures related to protecting the instrument panel of a vehicle against vandalism or sunlight, such configurations do little to protect the vehicle instrument panel from contaminants. What is needed, therefore, is a device for protecting at least a portion of an instrument panel from water, dust and other contaminants.

### SUMMARY

According to a first aspect, the present invention provides a system for protecting a portion of a vehicle interior including a protective cover configured to overlay at least a portion of a vehicle trim panel. The cover may include a sealing edge along at least a portion of the perimeter of the cover, and the cover may be removably retainable to the instrument panel.

According to another aspect, the present disclosure provides a protective cover for an instrument panel including a cover member adapted to overlie at least a portion of an instrument panel. The cover may further include at least one feature capable of releasably retaining the cover to the instrument panel, and may include a sealing edge around at least a portion of the cover member on a side adjacent the instrument panel.

### BRIEF DESCRIPTION OF THE DRAWINGS

Features and advantages of the claimed subject matter are set forth by way of description of various embodiments consistent therewith, which description should be considered in conjunction with the accompanying drawings, in which like parts are indicated with like numerals having sequential alphabetic characters appended to indicate varying embodiments of such parts, and wherein:

FIG. 1 illustrates one embodiment of an instrument panel protection system consistent with the present invention in a perspective view;

FIG. 2 is a sectional view of the instrument panel protection system of FIG. 1 taken along section A-A;

FIG. 2a is an enlarged view of a first region of the sectional view of FIG. 2;

FIG. 2b is an enlarged view of a second region of the sectional view of FIG. 2;

FIG. 2c is an enlarged view of a third region of the sectional view of FIG. 2; and

FIG. 3 is a sectional view of the instrument panel protection system of FIG. 1 taken along section B-B.

### DETAILED DESCRIPTION OF THE INVENTION

As noted above, the present disclosure relates to a protection system for portions of a vehicle interior, particularly an instrument panel of a vehicle. The protection system herein includes a removable protective cover that may be disposed over at least a portion of a vehicle instrument panel, or other interior trim component. The protective cover may eliminate or reduce access of water, dirt, or other contaminants to at least a portion of the instrument panel on which the protective cover is disposed. The protective cover may, therefore, prevent damage and/or fouling of electrical systems/components, electrical controls, or moving components from water, dirt, or other contaminants that may come in contact with, or accumulate on the instrument panel. According to another embodiment, the protective cover may also cover at least a portion of a defroster grille, air vent, glove box, air bag door, etc. to prevent or reduce the accumulation or access of moisture, dirt, etc. on those regions of the instrument panel protected by the protective cover herein. According to a further embodiment, the protective cover may be configured to overlie regions of the instrument panel that are not in use during normal or limited operation of the vehicle.

The protective cover herein may be a rigid (e.g. flexural modulus equal or greater than above 300,000 psi), a semi-rigid (e.g., flexural modulus between about 100,000-300,000 psi), or a flexible member (less than about 100,000 psi), or may include both rigid and flexible regions. In one embodiment the protective cover may be removably secured to a vehicle instrument panel using a push-on attachment scheme. Such a push-on attachment scheme may include the use of mechanical features, such as hooks, snap-fits, friction fits, etc., to releasably retain the protective cover to the instrument panel by engaging controls, knobs, air outlets, part edges, etc. located in, on, around, or associated with, the portion of the instrument panel receiving the protective cover or an adjacent region of the instrument panel. According to another embodiment, the protective cover may be removably retained to the instrument panel using a cling attachment scheme in which at least a portion of the inner surface of the protective cover may include a material that releasably adheres to at least a portion of the instrument panel, or frictionally engages at least a portion of the instrument panel. Further, the protective cover may employ a combination of push-on attachment features along with cling attachment characteristics.

Consistent with the present invention, the protective cover may be easily applied to the instrument panel when needed, such as during times of greater exposure to water, dirt, etc., for example in the rain or during off-road driving. When the protective cover is not needed, it may be easily removed from the instrument panel and stowed elsewhere in the vehicle. Additionally, the protective cover may be removed from the vehicle to facilitate cleaning of the protective cover.

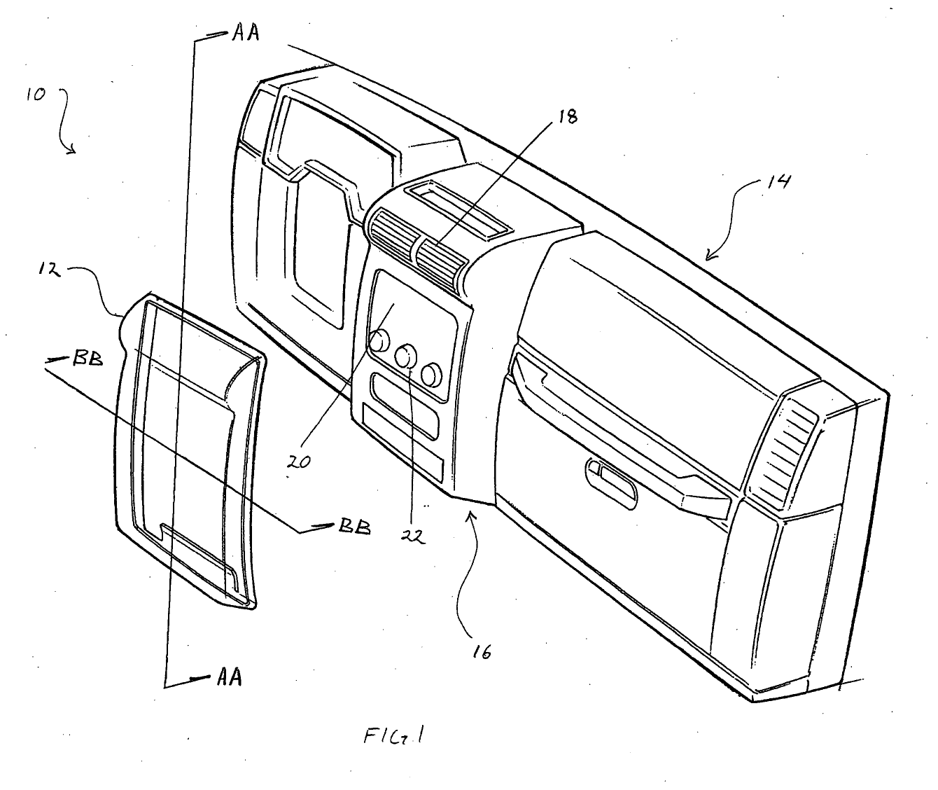

Referring to the drawings, FIG. 1 shows one embodiment of an instrument panel protection system 10 in an exploded perspective view. As shown, the instrument panel protection system 10 includes a protective cover 12 that is configured to be removably received over at least a portion of an instrument panel 14. In the illustrated embodiment, the protective cover 12 is configured to be removably received over a “center stack” 16 portion of the instrument panel 14. The center stack 16 portion of the instrument panel 14 may be a slightly protruding, central portion of the instrument panel 14 which may house various components, such as a center HVAC air outlet 18, a vehicle audio system 20, HVAC controls 22, etc. It will be understood that the center stack 16 portion of the instrument panel 14 may include additional or different components and features. Other and/or larger regions of an instrument panel 14 than the center stack 16 may also be protected using a system 10 consistent with the present invention as well as other portions of the interior of a vehicle, including but not limited to, consoles, door panels, the package shelf, seats, and air bags.

Consistent with the illustrated embodiment, the protective cover 12 may be shaped to at least generally follow the contour of the center stack 16 in the region of the center stack 16 over which the protective cover 12 may be disposed. In the illustrated embodiment, the protective cover 12 is shown to be generally sized and shaped to be removably disposed over the frontal portion of the center stack 16. The illustrated protective cover 12 is shown generally configured as a shallow box having an open back. As such, the protective cover may not only overlie the frontal portion of the center stack 16, but may also overlie at least a portion of the sides of the protruding center stack 16. Accordingly, the protective cover 12 may reduce or eliminate exposure of the frontal portion of the center stack 16 to water, dirt, and/or other contaminants. The center HVAC air outlets 18, vehicle audio system 20, as well as the HVAC controls may all, therefore, be protected against exposure to water, dirt, and other contaminants.

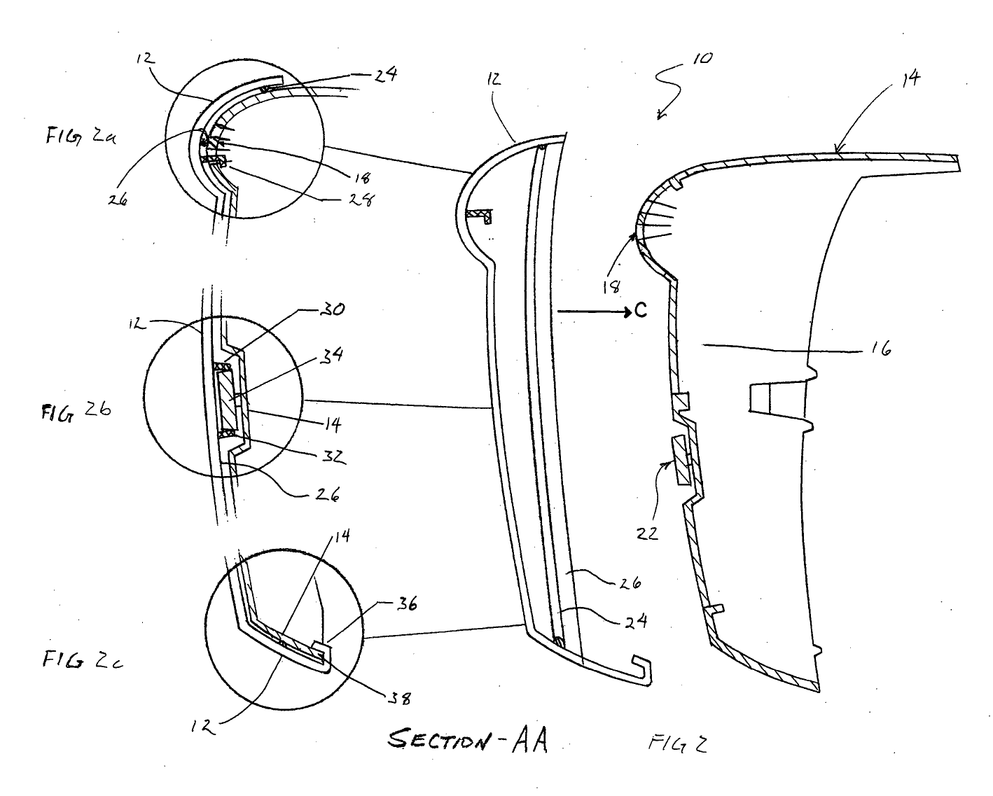

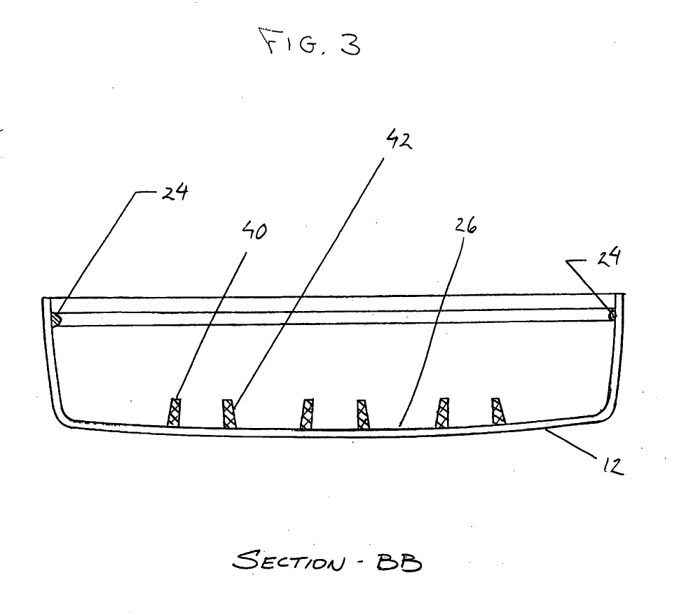

FIGS. 2 and 3 illustrate sectional views of the instrument panel protection system 10 illustrated in FIG. 1. The protective cover 12 shown in the sectional views of FIGS. 2, 2a-c and 3 make use of a push-on attachment scheme to removably retain the protective cover in position on the instrument panel 12, by providing mechanical features that may engage controls, knobs, air outlets, part edges, etc.

FIG. 2 shows the instrument panel protection system 10 of FIG. 1 in a sectional view taken along line A-A. As shown, the protective cover 12 may be contoured to generally conform to the geometry of the portion of the instrument panel 14 to be covered, for example the center stack 16 in the illustrated embodiment. Providing the protective cover 12 closely overlying the center stack 16 may allow the protective cover to be minimally obtrusive when received over the center stack 16. It should be understood, however, that while the illustrated protective cover 10 is provided closely to overlie and conform to the center stack 16 this is not a critical feature.

The protective cover 12 may include a seal 24 disposed on an inside surface 26 of the protective cover 12. The seal 24 may be formed as a rib, bead, or other protrusion at the margin of the inside surface 26 of the protective cover. As can most clearly be seen in FIG. 2a, the seal 24 may provide a line of contact between the protective cover 12 and the instrument panel 14. The line of contact formed by the seal 24 may reduce or prevent the ingress of water, dirt, etc. between the protective cover 12 and the instrument panel 14. Accordingly, the protective cover 12 may provide greater protection against contaminants for the region of the instrument panel 14 bounded by the seal 24. The seal 24 may extend around the entire circumference of the protective cover 12. Alternatively, the seal 24 may extend around only a portion of the protective cover 12. For example, if the seal 24 is disposed around an upper region of the protective cover 12, the seal may prevent water from traveling down the front of the center stack 16.

The seal 24 may be a flexible and/or elastomeric material that may conform to the surface of the instrument panel 14. In some embodiments, the seal 24 may not only conform to the contour of the instrument panel 14, but may also at least slightly deform under to contact pressure between the protective cover 12 and the instrument panel 14. The at least slight deformation of the seal 24 may provide a more secure seal against the ingress of water, dirt, etc.

According to another embodiment, the protective cover 12 may be provided without a protruding seal between the inside surface 26 of the protective cover 12 and the instrument panel 14. Instead of a protruding seal, the protective cover 12 may be provided having a close tolerance fit between the inside surface 26 of the protective cover and the instrument panel 14. In some embodiments the inside surface 26 of the protective cover 12 may be in contact with the instrument panel 14, or shaped to closely conform to the contour of the instrument panel 14, about at least a portion of the circumference of the protective cover 12. The small clearance between the inside surface 26 of the protective cover 12 and the instrument panel 14 may reduce the amount of dirt, water, etc. that reaches the portion of the instrument panel 14 covered by the protective cover 12. The protective cover 12 is mounted to the instrument panel 14 by overlaying the cover 12 onto the outer surface of the instrument panel 14 in the direction of arrow C. FIGS. 2a-c show various sections of the cover and panel removably engaged.

Turning to FIGS. 2a through 2c various features for removably retaining the protective cover 12 to the instrument panel 14 are illustrated. While the various features are shown associated with specific locations on the protective cover and elements of the instrument panel, it should be understood that the mechanical features used to removably retain the protective cover and the location of such features is dependent upon the shape of the portion of the instrument panel to be covered and the type and location of components and features on the instrument panel.

Turning first to FIG. 2a, a detailed, partial sectional view of an upper portion of the protective cover 12 assembled to the instrument panel 14 taken along line A-A of FIG. 1 is shown. The protective cover 12 is illustrated including a hook feature 28 extending inwardly from the inside surface 26 of the protective cover 12. The hook feature 28 may be at least partially received in a center HVAC air outlet, generally indicated at 18. The hook feature 28 may releasably engage an element of the HVAC air outlet 18, such as a louver of the outlet register, an air outlet bezel, a divider, etc. When the hook feature 28 is engaged with an element of the air outlet 18 the hook feature 28 may releasably retain at least an upper portion of the protective cover 12 to the instrument panel 14.

Releasable engagement between the hook feature 28 and an element of the air outlet may include a variety of aspects. First, the hook feature 28 may be provided as a resiliently deformable member. Accordingly, the hook feature 28 may resiliently deflect to releasably engage and to release an element of the air outlet 18. The resiliently deformable character of the hook feature 28 may be a result of a material characteristic, for example, the hook feature 28 and/or at least a portion of the protective cover 12 may be formed from a flexible or resilient material. The resiliently deformable character of the hook feature may also be achieved by designing the hook feature 28 as a flexible cantilever member.

One aspect of the releasable engagement of the hook feature 28 and an element of the air outlet 18 may include a tapered lead-in and/or let-off of the hooked feature 28. That is, an end portion of the hook feature 28 may be tapered such that when the hook feature 28 is pushed onto the air outlet 18 the tapered lead-in may bear against a portion of the air outlet 18 and cause the hook 28 to deflect. Once the hook 28 moves past the portion of the air outlet 18 the hook 28 may recover to engage the air outlet 18. Similarly, the hook may include a tapered let-off to facilitate release of the hook 28 from the air outlet. Accordingly, the hook 28 may release from the air outlet 28 by pulling on the protective cover 12. Pulling the protective cover 12 away from the air outlet 18 may cause the tapered let-off to bear against a portion of the air outlet 18 and deflect the hook 28 away from the portion of the air outlet 18. Once the hook 28 has cleared the air outlet 18 the hook 28 may recover to a neutral or un-deflected condition.

FIG. 2b provides a partial sectional view of the protective cover 12 assembled to the instrument panel 14, showing a central region including the HVAC controls 22 in detail. As shown, the protective cover 12 may include snap-fits 30 and 32 extending from the inside surface 26 of the cover 12. The snap-fits 30, 32 may releasably engage a control knob 34 or like feature on the instrument panel 14. When the snap-fits 30, 32 are engaged with the control knob 34 the protective cover 12 may be releasably retained to the instrument panel 14 in the region of the HVAC controls 22, such as shown in FIG. 2b. The control knob 34 may be an HVAC control, a vehicle audio system control, etc.

Releasable engagement of the control knob 34 by the snap-fits 30, 32 may be achieved through a variety of mechanisms. For example, in the illustrated embodiment the snap-fits 30, 32 are angled inwardly toward the control knob 34 and spaced appropriately to frictionally engage the edges of the control knob 34. Alternatively, the snap-fits 30, 32 may include inward barbs or hooks on the ends thereof that may releasably engage the rear of the control knob 34. Those having skill in the art will appreciate numerous additional conventional configurations by which the snap-fits or similar features may releasably engage the control knob.

Turning next to FIG. 2c, a detailed partial sectional view of the bottom portion of the protective cover 12 assembled to the instrument panel 14 is shown. In the illustrated embodiment, the protective cover 12 may be provided with a J-shaped or U-shaped hook 36 that may engage a lip or bottom edge 38 of the instrument panel 14 and retain the lower region of the protective cover 12 to the instrument panel 14. The lower region of the protective cover 12 may include one or more such hooks for retaining the protective cover 12 to the instrument panel 14. Consistent with another embodiment, rather than including a hook, the lower region of the protective cover may include one or more flanges, ribs, etc., that may extend upwardly behind the lip or edge of the instrument panel to thereby retain the lower region of the protective cover 12 to the instrument panel 14.

Referring to FIG. 3, a sectional view of the protective cover 12 about line B-B of FIG. 1 is shown. Consistent with the illustrated embodiment, the protective cover 12 may include one or more sets of snap-fits 40, 42 extending from the inside surface 26 of the protective cover. The snap-fits 40, 42 may be provided having a structure that may be generally similar to the snap-fits 30, 32 illustrated in FIG. 2b. The snap-fits 40, 42 may also releasably engage a control knob or other protruding feature on the instrument panel 14. According to one embodiment, the snap-fits 40, 42 may operate in concert with the snap-fits 30, 32 to more securely retain the protective cover 12 to the instrument panel 14. According to such an arrangement, the snap-fits 40, 42 may be oriented generally perpendicular to the snap-fits 30, 32 to thereby capture a control knob horizontally as well as vertically. The snap-fits 30, 32 and 40, 42 may of course be provided having an angular relationship other than perpendicular. Additionally, it should be understood that greater or fewer snap-fits may be disposed about the circumference of a control knob for releasably engaging the knob. Further, the snap-fits 40,42 may frictionally engage openings in the face of the instrument panel 14 to provide retention of the protective cover 12.

FIG. 3 additionally illustrates the seal 24 preferably extending around the entire inner circumference of the protective cover 12. As discussed previously, the seal 24 need not be provided around the entire inner circumference of the protective cover 12, but rather may extend around only a portion thereof, and/or may be provided in a discontinuous arrangement.

The embodiment of the protective cover 12 illustrated in FIGS. 1 through 3 may be quickly and easily installed over the center stack 16 of the instrument panel 14 when needed. The protective cover 12 may be installed by orienting the protective cover 12 so that the upper portion of the protective cover 12 is angled outwardly from the instrument panel 14. The hook 36 on the lower portion of the protective cover 12 may be engaged with the lip or edge 38 of the instrument panel 14 (See FIG. 2c). The protective cover 12 may then be pivoted toward the instrument panel 14 (in the direction of arrow C) engaging the snap-fits 30, 32, 40, 42 with a control knob 34, and engaging the hook 28 with the air outlet 18. The engagement of the various features of the protective cover 12 may releasably retain the protective cover 12 in position over the center stack 16 of the instrument panel 14. Consistent with the foregoing description, when the protective cover 12 is retained in position over the center stack 16, the seal 24 may be pressed against, or placed in close proximity to, the instrument panel 14 to further prevent or reduce the ingress of water, dirt, etc.

In a corresponding manner, the protective cover 12 may also be easily removed from the instrument panel 14. In a generally reverse order, the hook 28 may be disengaged from the air outlet 18 by pulling the upper portion of the protective cover 12 outwardly from the instrument panel 14. An outward force applied to the protective cover 12 may also release the snap-fits 30, 32, 40, 42 from the control knob 34. Finally, the hook 36 on the lower portion of the protective cover 12 may be disengaged from the lip or lower edge 38 of the instrument panel 14. After removal the protective cover 12 may be stored in a convenient location within the vehicle.

It should be understood that the specific features for releasably engaging the various portions of the instrument panel are set forth by way of example and should not be construed as limiting. The exact features employed and the location thereof is susceptible to variation based on design considerations as well as the layout and configuration of the portion of an instrument panel to be covered. Similarly, the process for securing and removing the protective cover may vary depending upon the specific features for releasably engaging the instrument panel and the arrangement of such features on the protective cover. Accordingly, the foregoing description should not be considered limiting on the invention herein.

According to another embodiment, rather than providing mechanical features, such as snap-fits, hooks, etc., to retain the protective cover to the instrument panel consistent with the above-described “push-on” attachment scheme, a protective cover may be releasably secured to an instrument panel using “cling attachment”. Cling attachment of the protective cover may rely on frictional, electro-static, hydrostatic, adhesive, etc. interaction between the protective cover and the instrument panel.

According to one embodiment, a protective cover may be provided having an interior surface that exhibits a frictional interaction with the instrument panel. Useful frictional interaction may be achieved by providing at least a portion of the interior surface including an elastomer or a relatively low durometer material, e.g. a durometer of less than or equal to about Shore 100A. A protective cover exhibiting a useful frictional interaction may be provided having at least a portion thereof that may generally conform to the region of the instrument panel to be covered by the protective cover. As such, at least a portion of the protective cover may contact at least a portion of the instrument panel in a deployed or installed condition. The frictional interaction between the portion of the interior surface of the protective cover and the corresponding regions of the instrument panel may be sufficient for the protective cover to resist sliding across the surface of the instrument panel. Consistent with such an embodiment, removal of the protective cover from the instrument panel may require applying a removal force at an angle away from the protective cover/instrument panel interface. Accordingly, a protective cover relying on frictional interaction between the protective cover and the instrument panel may resist being displaced, for example, when traveling over rough terrain, inclined surfaces, etc. In some embodiments herein, the protective cover may be formed from a flexible material, such as cloth or film, that may “drape” on the instrument panel, and/or have a shape that closely and readily conforms to the shape of the instrument panel. As such, the area of the contact interface between the protective cover and the instrument panel may be increased. Increasing the area of contact may in-turn increase the frictional interaction between the protective cover and the instrument panel.

According to another embodiment, cling attachment between of the protective cover and the instrument panel may be provided by electro-static interaction between the protective cover and the instrument panel. Consistent with such an embodiment, the protective cover may be formed from a material that may be susceptible to becoming electrostatically charged. When the electrostatically charged protective cover is placed on the instrument panel, the protective cover may exhibit electrostatic cling to the instrument panel. The “static-cling” experienced by the protective cover may be increased by increasing the contacting surface area between the protective cover and the instrument panel. As discussed above regarding frictional engagement, the area of the contact interface between the protective cover and the instrument panel may be increased by forming the protective cover from a flexible material that may drape onto the instrument panel and/or by providing the protective cover having a size and shape that may closely fit at least a portion of the instrument panel.

In a related embodiment, cling attachment of the protective cover onto the instrument panel may be achieved by creating an atmospheric pressure lock between at least a portion of the protective cover and the instrument panel. An atmospheric pressure lock may be created between the protective cover and the instrument panel by providing the protective cover formed from a flexible material, such as a thermoplastic or thermoset elastomer, that may closely conform to the size and shape of the instrument panel. Once such a protective cover is applied to the instrument panel, any attempt at removal of the protective cover, other than by peeling the cover off of the instrument panel, may tend to create a vacuum between the instrument panel and the protective cover. The vacuum between the protective cover and the instrument panel may resist removal of the protective cover other than by peeling.

According to yet another embodiment, cling attachment of the protective cover to the instrument panel may include the use of an adhesive, e.g. a pressure sensitive adhesive, to retain the protective cover to the instrument panel. The adhesive may be provided in predetermined locations between the protective cover and the instrument panel. Alternatively, the adhesive may be provided as a generally continuous layer between the protective cover and the instrument panel. According to one embodiment, the adhesive may be provided on the inside surface of the protective cover 12. Consistent with such an embodiment, the protective cover 12 may be positioned directly on the instrument panel 14, thereby also positioning the adhesive in the predetermined locations relative to the protective cover and the instrument panel. In one embodiment, the adhesive may exhibit a greater adhesion to the protective cover than to the instrument panel. Consistent with such an embodiment the adhesive may remain on the protective cover when the protective cover is removed from the instrument panel. Accordingly, transfer of adhesive residue to the instrument panel may be minimized.

According to still another embodiment, the protective cover and the instrument panel may include corresponding regions of cooperating hook and loop type fasteners, such as available under the trade name VELCRO®. The hook and loop fasteners may be an integrated feature of the instrument panel and/or the protective cover. Alternatively, the hook and loop fasteners may be applied to the instrument panel and/or the protective cover, for example in the form of a tape that may be adhesively bonded to the instrument panel and/or the protective cover.

Various other cling attachment mechanisms may also suitably be employed for removably retaining a protective cover herein to a vehicle instrument panel. Additionally, various aspects of the discussed cling attachment mechanisms may be combined to provide a protective cover that may be removably retained to a vehicle instrument panel.

Consistent with the present disclosure, various aspects of push-on attachment may be used in combination with aspects of cling attachment. The use of both attachment schemes in a single protective cover may allow greater freedom of design and allow portions of an instrument panel that do not present a protruding region to be effectively protected against water, dirt, etc. Further advantages available by utilizing aspects of both attachment schemes, may include, for example, more securely retaining the protective cover to and instrument panel, greater resistance to the ingress of contaminants, etc.

A protective cover consistent with the present invention may be formed from a variety of different materials. According to a preferred embodiment, a protective cover consistent with the present invention may be formed from a polymeric material. According to one embodiment, the protective cover may be formed from a rigid or semi-rigid polymeric material. Alternatively, the protective cover may be formed from a flexible polymeric material. Additionally, the protective cover herein may be formed from a combination of rigid, semi-rigid, and/or flexible polymeric materials.

For example, the protective cover may be formed from a rigid or semi-rigid polymeric material, such as a polyolefin, polyvinyl chloride, acrylonitrile-butadiene-styrene, nylon, etc. It should be understood, however, that the rigidity of the protective cover may be a function of the thickness of the protective cover, as well as being a function of the material properties. Furthermore, the incorporation of reinforcing features such as ribs, etc., may also influence the rigidity of the protective cover. In addition to providing protection against water, dirt, etc. the use of a rigid or semi-rigid polymeric material may afford at least some degree of impact resistance. Accordingly, the protective cover may provide at least limited protection of the underlying instrument panel, as well as any components or features thereof, against objects striking the instrument panel through the protective cover. Additionally, a rigid or semi-rigid material may provide adequate engaging strength of features used to releasably retain the protective cover to the instrument panel, such as snap-fits, hooks, etc.

Flexible and/or low durometer materials, such plasticized polyvinyl chloride, thermoplastic elastomers, polyurethane elastomers, natural rubber, butadiene rubber, etc. may also suitably be used for producing a protective cover consistent with the present invention. The flexible characteristic of such materials may allow the protective cover to more closely conform to the geometry of the instrument panel to be covered. Greater conformance to the contours of the instrument panel may improve the ability of the protective cover to exclude water, dirt and other contaminants from the instrument panel. This aspect may be enhanced by providing a tight fit between the instrument panel and the protective cover, for example by requiring the protective cover to resiliently stretch over, or onto, the instrument panel, thereby achieving greater sealing of the protective cover against the instrument panel.

Additionally, flexible materials, particularly elastomeric materials, used to produce the protective cover may also provide some degree of impact protection for the underlying regions of the instrument panel. Rather than providing a rigid cover however, a flexible material may provide impact protection by cushioning an impact. Furthermore, the use of a flexible material may allow at least limited operation of controls disposed beneath the protective cover, particularly push buttons and toggle switches, although it may also be possible to operate a variety of controls through the protective cover.

Features and advantages of rigid or semi-rigid materials and flexible material may be achieved in a single protective cover by providing the protective cover including regions of a rigid and/or semi-rigid material and regions of a flexible material. For example, a protective cover may be provided having a sealing edge including a flexible peripheral region to enhance sealing of the protective cover against the instrument panel. Regions of the protective cover including securing features, however, may be formed from a rigid or semi-rigid material to provide more secure attachment of the protective cover to the instrument panel. Similarly, a region of a flexible material may be provided overlying at least some of the controls disposed on the instrument panel. The region of flexible may allow at least limited operation of such controls. The same protective cover may, for example, also include a region of a rigid material overlying a sensitive component, such as a vehicle audio system, to provide greater resistance against impact in the region of the sensitive component.

Various other useful combinations of rigid and/or semi-rigid and flexible materials may be employed to provide a protective cover having different desired characteristics. For example, a flexible material may be provided overlying either a portion of the inside or the outside of an otherwise rigid or semi-rigid protective cover. For example, a peripheral region of the inside surface of the protective cover may include a flexible material to improve sealing of the protective cover to the instrument panel. According to one embodiment, the flexible material may be configured as a bead or seal extending around at least a portion of an interior surface of the protective cover.

According to one embodiment, a protective cover may be provided including a transparent or translucent portion overlying a display, gauge, or similar visually information display. The use of a transparent or translucent portion may permit the visually presented information to be read by an operator or passenger of the vehicle. According to one embodiment consistent with this aspect, the entire protective cover may be formed from a transparent or translucent material. Alternatively, only a portion or the protective cover associated with the visually presented information may be transparent or translucent.

A wide variety of manufacturing processes may be used to produce a protective cover consistent with the present disclosure. For example, conventional plastics processing techniques including injection molding, compression molding, blow molding, thermoforming, rotational molding, transfer molding and the like may all suitably be used to form a protective cover herein. Various other manufacturing processes may also suitably be employed to form a protective cover for an instrument panel.

A protective cover having, for example, a first region including a rigid material and a second region including a flexible material, may be formed using a variety of techniques, including insert-molding, co-injection molding, welding or bonding separately formed portions, etc. In the case of an insert-molded protective cover having a region of a rigid material and a region of a flexible material, either the rigid or flexible portion may be first formed from a first material using a suitable manufacturing process. The first formed portion may then be positioned in an injection or compression mold in which the mold together with the first formed portion defines a mold cavity including the second portion. The second portion may then be molded from the second material. In some cases it may be desirable to provide a feature around at least a portion of the periphery of the first formed part to promote mechanical bonding between the first and second portions. For example, the edge of the first formed portion may include an undercut or a protrusion that may become mechanically locked to the second material. Similarly, at least a portion of the periphery of the first formed portion may have a thickness that is less than the desired final thickness of the corresponding region of the protective cover. The second portion may then be formed to overlap the periphery of the first formed portion to provide a lap joint between the first and second portions.

A protective cover having both rigid and/or semi-rigid portions and flexible portions may also be formed by co-injection molding. In a manner similar to the insert molding process described above, a first portion of the protective cover may be molded from a rigid, semi-rigid, or flexible material. However, rather than demolding the first portion, the mold may be adjusted to define a mold cavity including the first portion and the mold. It will be understood that such adjustment of the mold may be accomplished using movable core components or by removing at least a portion of the mold and replacing it with a second mold portion.

According to one particular embodiment, a rigid or semi-rigid protective cover may be formed having soft or resilient outer surface and sealing edge. A protective cover consistent with this embodiment may be formed using the Intellimold™ injection molding process described in U.S. Pat. Nos. 6,645,587; 6,019,918; 5,863,487; 5,728,329; 5,716,561; 5,662,841; and 5,441,680. Consistent with the Intellimold™ process, an injection molded article may be formed from a combination of materials wherein the materials may preferentially separate according to their modulus, to form a generally layered structure in which the lower modulus material may be disposed at an exterior region of the molded article and the higher modulus material may be disposed at an internal region of the molded article. A suitable protective cover may formed by injection molding a polypropylene material together with a thermoplastic elastomer, such as Santoprene™ thermoplastic elastomer, available from Advanced Elastomer Systems, L.P., using the Intellimold™ process. The resultant protective cover may include an outer layer of thermoplastic elastomer disposed over a polypropylene core. According to one aspect, a protective cover consistent with this embodiment may provide a soft sealing edge, that is, a contacting surface of the protective cover, or a seal feature of the protective cover that may include an elastomeric exterior. A soft sealing edge according to this aspect may improve the seal between the protective cover and the instrument panel.

While the embodiments illustrated and described herein relate to a cover for protecting at least a portion of the center stack region of a vehicle instrument panel, it will be understood that the various described aspects may be suitably applied to additional and/or different regions of a vehicle instrument panel. For example, the cover may be extended to protect a top surface of the instrument panel, including, for example, the vents for the windshield defroster, speaker grilles, etc.

According to one embodiment, the cover may be configured to cover only those controls and/or components that are not necessary for normal driving or off-road driving. However, the cover may be configured to provide more extensive protection. While a more extensive instrument panel protection system may not be suitable for use when driving, it may provide protection for an exposed instrument panel, such as of a convertible vehicle, when the vehicle is not being driven.

What is claimed is:

1. A system for protecting a vehicle trim panel comprising:
a protective cover configured to overlay at least a portion of a vehicle trim panel, said trim panel housing one or more functional components, said cover comprising an edge along at least a portion of the perimeter of said cover and an inner surface, said cover being removably retained to said panel.

2. A system according to claim 1 wherein said protective cover comprises at least one feature releasably engageable with a feature of said panel to removably retain said cover to said panel.

3. A system according to claim 2 wherein said feature is capable of releasably engaging an HVAC air outlet of disposed in said panel.

4. A system according to claim 3 wherein said feature comprises a hook capable of releasably engaging at least one of a louver of an outlet register, a bezel, or a divider of said HVAC air outlet.

5. A system according to claim 2 wherein said feature is capable of releasably engaging a control feature disposed on said panel.

6. A system according to claim 5 wherein said feature comprises a snap-fit capable of releasably engaging a control knob disposed on said panel.

7. A system according to claim 6 wherein said protective cover comprises a plurality of snap-fits capable of releasably engaging a control knob disposed on said panel.

8. A system according to claim 2 wherein said feature is capable of releasably engaging one of an edge or a seam of said panel.

9. A system according to claim 8 wherein said feature comprises a hook capable of releasably engaging an edge of said panel.

10. A system according to claim 8 wherein said feature comprises a flange capable of releasably engaging an edge of said panel.

11. A system according to claim 1 wherein said edge comprises a bead capable of sealingly engaging at least a portion of said panel when said protective cover is retained to said panel.

12. A system according to claim 11 wherein said bead comprises a flexible material disposed around at least a portion of the perimeter of said protective cover.

13. A system according to claim 1 comprising an adhesive disposed between at least a portion of said protective cover and said panel, said adhesive capable of removably retaining said protective cover to said panel.

14. A system according to claim 12 wherein said adhesive comprises an adhesive which remains tacky as disposed on at least a portion of the inner surface of said protective cover.

15. A system according to claim 13 wherein said adhesive comprises a pressure sensitive adhesive.

16. A system according to claim 1 wherein at least a portion of the inner surface of said protective cover is frictionally engaged to said panel.

17. A system according to claim 1 wherein said inner surface comprises a material with durometer of less than or equal to about Shore 100A.

18. A system according to claim 1 wherein said protective cover comprises any one or a combination of a rigid polymeric material, a semi-rigid polymeric material and a flexible polymeric material.

19. A system according to claim 1 wherein said protective cover is removeably retained to said panel by any one or a combination of hook-and-loop fasteners, electrostatic charge, vacuum, and friction due to said cover substantially conforming to the panel shape.

20. A system according to claim 1 wherein at least a portion of said protective cover comprises a transparent or translucent polymer.

21. A system according to claim 20 wherein said transparent or translucent protective cover is sufficiently flexible to permit adjustment of said functional components through said cover.

22. A protective cover for an instrument panel comprising:
a cover member adapted to overlie at least a portion of an instrument panel;
at least one feature capable of releasably engaging said cover to said instrument panel; and
an edge around at least a portion of the inner surface said cover member adjacent said instrument panel.

23. A protective cover according to claim 22 wherein said feature comprises a member capable of releasably engaging at least a portion of an HVAC air outlet disposed on said instrument panel.

24. A protective cover according to claim 23 wherein said feature comprises a hook.

25. A protective cover according to claim 22 wherein said feature comprises at least one snap-fit capable of releasably engaging a control knob disposed on said instrument panel.

26. A protective cover according to claim 22 wherein said feature comprises a hook capable of releasably engaging an edge of said instrument panel.

27. A protective cover according to claim 22 wherein said feature comprises a flange capable of releasably engaging an edge of said instrument panel.

28. A protective cover according to claim 22 wherein said edge comprises an elastomeric material.

29. A protective cover according to claim 28 wherein said edge comprises a bead of elastomeric material.

30. A protective cover according to claim 22 wherein said cover member comprises polypropylene having a layer of thermoplastic elastomer disposed over at least a portion of the inner surface of said cover.

31. A protective cover according to claim 22 comprising an adhesive disposed between at least a portion of said protective cover and said panel, said adhesive capable of releasably engaging said protective cover to said panel.

32. A protective cover according to claim 31 wherein said adhesive comprises a layer of adhesive which remains tacky as disposed on at least a portion of the inner surface of said protective cover.

33. A protective cover according to claim 22 wherein said adhesive comprises a pressure sensitive adhesive.

34. A protective cover according to claim 22 wherein at least a portion of the inner surface of said protective cover is frictionally engaged to said panel.

35. A protective cover according to claim 34 wherein said inner surface comprises a material with durometer of less than or equal to about Shore 100A.

36. A protective cover according to claim 22 wherein said protective cover comprises any one or a combination of a rigid polymeric material, a semi-rigid polymeric material and a flexible polymeric material.

37. A protective cover according to claim 22 wherein said protective cover is releasably engaged to said panel by any one or a combination of hook-and-loop fasteners, electrostatic charge, vacuum, and friction due to said cover substantially conforming to the panel shape.

38. A protective cover according to claim 22 wherein at least a portion of said protective cover comprises a transparent or translucent polymer.

39. A protective cover according to claim 38 wherein said transparent or translucent protective cover is flexible enough to allow adjustment of said functional components through said cover.
